(19) United States
(12) Patent Application Publication
(10) Pub. No.: US 2025/0302035 A1
(43) Pub. Date: Oct. 2, 2025

(54) THERMOPLASTIC POLYMER MATERIALS WITH EMBEDDED AND SURFACE-CONCENTRATED NANOPARTICLES

(71) Applicant: EVOQ NANO, INC., Salt Lake City, UT (US)

(72) Inventor: William H. Niedermeyer, West Jordan, UT (US)

(21) Appl. No.: 19/093,037

(22) Filed: Mar. 27, 2025

Related U.S. Application Data
(60) Provisional application No. 63/571,149, filed on Mar. 28, 2024.
(60) Provisional application No. 63/775,632, filed on Mar. 21, 2025.

(51) Int. Cl. A01N 25/10; A01N 25/12; A01N 59/16; A01P 1/00; C08J 3/205; C08J 7/04; C08K 7/18

(52) U.S. Cl. CPC A01N 25/10; A01N 25/12; A01N 59/16; A01P 1/00; C08J 3/2053; C08J 7/0427; C08K 7/18; C08K 2201/011

(57) ABSTRACT

Disclosed are thermoplastic polymer materials, and polymer products (e.g., medical devices) made therefrom, that incorporate metal nanoparticles. The metal nanoparticles impart antimicrobial activity to the thermoplastic polymer materials. The thermoplastic polymer materials can be manufactured or processes in a manner that causes metal nanoparticles within the interior of the thermoplastic polymer to beneficially migrate to the surface portion of the thermoplastic polymer (i.e., an outer 100 nm of the thermoplastic polymer), where contact with microbes is more likely to occur. Resulting polymer products, such as medical devices, include a higher concentration of metal nanoparticles at the surface portion, where antimicrobial effects are most useful, as compared to the interior bulk portion of the thermoplastic polymer. The surface portion can include up to 10 times the concentration of metal nanoparticles than the interior bulk portion. The concentration of metal nanoparticles in at least the surface portion can be 2-2000 ppm, 10-1400 ppm, 20-1000, 30-500 ppm, 50-250 ppm, or 70-150 ppm.

### CROSS-REFERENCE TO RELATED APPLICATIONS

This application claims the benefit of U.S. Provisional Application No. 63/775,632, filed Mar. 21, 2025, and U.S. Provisional Application No. 63/571,149, filed Mar. 28, 2024, which are incorporated by reference in their entirety.

### BACKGROUND

### Technical Field

This disclosure relates to thermoplastic polymer materials that comprise a thermoplastic polymer and metal nanoparticles incorporated therein, with a higher concentration of metal nanoparticle disposed at the polymer surface compared to the interior bulk, medical device and other polymer products formed therefrom, and related manufacturing processes.

### Related Technology

Polymeric articles of manufacture may be manufactured using injection molding processes. One issue with injected-molded polymers is that the surface finish of the product can be sponge-like, with pores that can extend several microns deep into the product. FIG. 1, for example, is a scanning transmission electron microscope (STEM) image of a surface of polystyrene from a thermal extruded pellet. The polymer surface has a high degree of porosity that can harbor bacteria and other microbes. Such microbial growth can be concerning for hospitals and others in the medical field. The management of polymers used in areas of high sensitivity, including many medical applications, requires expensive and rigorous sterilization and storage procedures. Even so, aggravated tissues and infections are known to result from the use of compromised polymers that are used to deliver substances to patients and/or implanted into patients. Drug resistant microbial infections may also result from the use of compromised polymeric products, causing expensive healthcare maintenance and even death.

The overuse of antibiotics and other antimicrobials has contributed to antibiotic resistant bacteria and other treatment-resistant microbes. There is concern that an increase in antibiotic and other antimicrobial resistance may lead to microbes that are untreatable with conventional technologies. Currently, there are few methods of disinfection and microbial control that don't require the use of conventional antibiotics and antimicrobials. In some cases, medical devices that incorporate antibiotics cannot stop the formation of biofilms and/or cannot prevent infection from bacteria having antibiotic resistance. In such cases, the use of antibiotics in polymeric materials does not protect the patient from infection and may even give a false sense of security.

There are attempts to incorporate ionic colloidal silver and silver nanoparticles made by conventional means into polymeric materials to import antimicrobial activity to the resulting products. However, antimicrobial resistance has now been discovered for colloidal silver (i.e., silver nanoparticles manufactured by conventional chemical reduction processes, typically using some form of capping agent) and ionic silver. McNeilly et al., “Emerging Concern for Silver Nanoparticle Resistance in Acinetobacter baumannii and Other Bacteria,” Front. Microbiol., 16 Apr. 2021, discuss the emergence of several antibiotic-resistant bacteria, including Acinetobacter baumannii, Enterococcus faecium, Staphylococcus aureus, Klebsiella pneumoniae, Acinetobacter baumannii, Pseudomonas aeruginosa, and Enterobacter spp. Of these, A. baumannii was of particular concern and was found to also have developed resistance to colloidal silver nanoparticles, as were E. Coli, Enterobacter cloacae, S. typhimurium, B. subtilis, S. aureus. P. aeruginosa, K. pneumoniae, Serratia marcescens, Acinetobacter spp.

Silver, “Bacterial silver resistance: molecular biology and uses and misuses of silver compounds,” FEMS Microbiology Reviews, Volume 27, Issue 2-3, June 2003, Pages 341-35, discusses silver-resistant Salmonella, and Escherichia coli. Elkrewi, et al., “Cryptic silver resistance is prevalent and readily activated in certain Gram-negative pathogens,” J. Antimicrob. Chemother., 2017 Nov. 1; 72(11):3043-3046 discloses colloidal silver nanoparticle resistance by gram negative pathogens, such as Enterobacter spp., Klebsiella spp. Escherichia coli, Pseudomonas aeruginosa, Acinetobacter spp., Citrobacter spp., and Proteus spp. Hosney, “The increasing threat of silver-resistance in clinical isolates from wounds and burns,” Infect Drug Resist. 2019; 12: 1985-2001 discusses colloidal silver-resistant Klebsiella pneumoniae, Staphylococcus aureus, Escherichia coli, Enterobacter cloacae, Pseudomonas aeruginosa, and Acinetobacter baumannii. Percival, et al., “Bacterial resistance to silver in wound care, J. Hospital Infection, Vol. 60, Issue 1, May 2005, pp. 1-7, discusses the fear and possibility of colloidal silver-resistant microbes in wounds. Kedziora, et al., “Consequences of Long-Term Bacteria's Exposure To Silver Nanoformulations With Different PhysicoChemical Properties,” Intl. J. of Nanomedicine, 2020:15 199-213, discusses colloidal silver-resistant gram positive and gram negative bacteria.

Conventional chemical synthesis processes involve combining a silver salt (typically silver nitrate) with a reducing agent (e.g., sodium borohydride, sodium citrate, hydrazine) and controlling the size of the nanoparticles using a capping agent (e.g., polyvinylpyrrolidone (PVP), polyvinyl alcohol (PVA), citrate ions, and surfactants like cetyltrimethylammonium bromide (CTAB)). Silver nanoparticles made by conventional chemical synthesis methods have external bond angles and edges where silver ions can be released, even though the bulk nanoparticles are ground state. Thus, so-called “spherical” nanoparticles made by chemical synthesis methods are not truly spherical and typically have a sphericity significantly less than 1, which defines a perfect sphere, with the sphericity typically being less than 0.96. Adding metal nanoparticles that release ions into polymers can undesirably lead to the release of silver ions, which can be toxic to human and animal tissues under excess exposure. Where silver ion release is the major mode of antimicrobial action, which is the case for conventional colloidal silver products, the antimicrobial activity of the polymer will likewise degrade over time.

Accordingly, there remains a need to find improved polymer materials that exhibit effective antimicrobial properties and that are effective for use in medical devices, including implantable medical devices.

### SUMMARY

Disclosed are thermoplastic polymer materials, and polymer products (e.g., medical devices) made therefrom, that incorporate metal nanoparticles. The metal nanoparticles impart antimicrobial activity to the thermoplastic polymer compositions. The polymer materials can be manufactured to cause metal nanoparticles within the interior of the polymer material to beneficially migrate to the surface of the material, where contact with microbes is more likely to occur. Resulting polymer products, such as medical devices, include a higher concentration of metal nanoparticles at the surface, where antimicrobial effects are most useful, as compared to the interior bulk.

The first step in manufacturing medical devices and other polymer products from thermoplastic polymer materials is to incorporate metal nanoparticles into a thermoplastic polymer to form an intermediate thermoplastic composition before subjecting the thermoplastic polymer to a shaping process (e.g., extrusion or injection molding). In some embodiments, a thermoplastic polymer in an appropriate form, such as thermoplastic polymer granules, can be treated (e.g., coated and/or impregnated) with metal nanoparticles (e.g., silver and/or gold nanoparticles) by providing a solution or dispersion of metal nanoparticles in a volatile solvent (e.g., water and/or organic solvent), applying the nanoparticle solution or dispersion to the thermoplastic polymer (e.g., polymer granules), optionally allowing the solvent and metal nanoparticles to penetrate into the thermoplastic polymer, and allowing the solvent to evaporate using means known in the art (e.g., through application of heat, moving dry gas, and/or reduced pressure), leaving the metal nanoparticles on and/or impregnated in the thermoplastic polymer to form an intermediate thermoplastic polymer composition. This process can optionally be repeated one or more times to increase the concentration of metal nanoparticles in the intermediate thermoplastic composition. Other modes of incorporating metal nanoparticles into thermoplastic polymers include providing metal nanoparticles within liquid prepolymer compositions that have not fully cured, within a precursor polymer component that reacts with other prepolymer components to yield a cured thermoplastic polymer, and/or within other components (e.g., catalysts) that are added to prepolymer compositions.

The intermediate thermoplastic polymer composition is then formed into a polymer product by an appropriate shaping process, such as by extrusion or injection molding. When the intermediate thermoplastic composition (e.g., metal nanoparticle-treated polymer granules) is heated into a molten state as part of the shaping process (e.g., within a forming apparatus, such as an auger, extruder, or injection molding machine), the metal nanoparticles become distributed throughout the molten thermoplastic polymer. In some embodiments, the molten thermoplastic polymer composition can be mixed, such as by an auger or other mixer, to cause the metal nanoparticles to be substantially homogeneously dispersed throughout the molten thermoplastic polymer composition prior to shaping. The molten thermoplastic polymer composition is formed into a desired shape of an intermediate polymer product (e.g., by extrusion or injection molding). As this point, the metal nanoparticles may be substantially evenly distributed throughout the intermediate polymer product, which is then cooled using appropriate cooling means, such as a cooling bath, in a manner that causes the nanoparticles to be more concentrated at the surface.

In some embodiments, the intermediate polymer product is cooled in a controlled manner that causes the metal nanoparticles to migrate to the surface so as to an have a higher concentration at the surface portion than in the interior bulk portion of the thermoplastic polymer material of the polymer product. In some embodiments, the surface portion is understood to be the outer 100 nm of the thermoplastic polymer (i.e., the cross-sectional thickness of the surface portion or outer layer). The distribution of metal nanoparticles in the polymer product is dependent on how the intermediate polymer product is cooled, with the metal nanoparticles apparently being drawn to the cooler surface if the thermoplastic polymer is cooled slowly and in a controlled manner.

In general, it has been found that metal nanoparticles can migrate toward cooler regions of a thermoplastic polymer as long as it remains sufficiently soft or molten to permit movement of metal nanoparticles therein. During controlled cooling, the metal nanoparticles can migrate toward the cooler region at the surface, with there being a balance between the temperature and rate of cooling because once the polymer surface portion has solidified, the metal nanoparticles can no longer migrate but become frozen in place.

In some embodiments, such as in the case of a continuously extruded intermediate polymer product, controlled cooling can be performed using a larger cooling bath at a warmer temperature than is otherwise common in the industry. Alternatively, controlled cooling can be performed using multiple cooling baths (e.g., two) that are progressively cooler. In still other embodiments, controlled cooling may be performed by providing a time delay between extrusion or demolding and when the intermediate extruded or demolded polymer product is placed in a cooling bath. Such delayed or controlled cooling permits the surface portion to be somewhat cooler than the interior bulk portion of the thermoplastic polymer, which draws the metal nanoparticles toward the cooler surface as long as the surface is not cooled so rapidly that it becomes solid or rigid too soon, which prevents migration of the metal nanoparticles toward the surface. In some embodiments, the cooling bath may contain metal nanoparticles that can become embedded within, and further increase the concentration of metal nanoparticles in, the surface portion of the thermoplastic polymer.

By comparison, fast quenching in a cold water bath may cause the surface to become so rigid that it prevents migration of metal nanoparticles to the surface. In some cases, fast quenching in a cold water bath may actually result in metal nanoparticles being drawn into softer regions of the thermoplastic polymer below the surface portion as a result of a large temperature gradient between a cooled rigid polymer surface and warmer and softer interior regions of the interior bulk portion. In such case, the concentration of metal nanoparticles at the surface may actually be lower than in regions of the interior bulk portion.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the disclosure will become apparent and more readily appreciated from the following description, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 is a STEM image of a surface of polystyrene from thermal extruded pellets;

FIGS. 2A-2B schematically illustrate a microbe after having absorbed spherical-shaped metal nanoparticle from a substrate and disulfide bonds being catalytically denatured by a spherical-shaped nanoparticle;

FIG. 3 illustrates a STEM image of silver (Ag) nanoparticles inside a MRSA SA62 drug resistant bacterium;

FIG. 4A illustrates a thermoplastic material with metal nanoparticles that are substantially evenly distributed throughout the bulk of the material and on the surface of the material;

FIG. 4B illustrates a thermoplastic material with an increased concentration of metal nanoparticles at the surface relative to the inner bulk of the thermoplastic material;

FIG. 4C illustrates a thermoplastic material with metal nanoparticles substantially evenly distributed throughout and additionally including a coating of a different polymer applied to the thermoplastic material;

FIGS. 5A and 5B illustrate thermoplastic materials within a quenching bath in a manner that increases metal nanoparticle concentration at the surface of the thermoplastic materials:

FIG. 6 is a STEM image of a thermoplastic material subjected to extrusion followed by a controlled cooling bath, showing accumulation of silver nanoparticles at the surface;

FIG. 7 illustrates results of biofilm efficacy testing, showing that silver nanoparticles formed via laser ablation, without capping agents or other coating agents, had greater antimicrobial efficacy than comparison nanoparticle compositions;

FIGS. 8A and 8B schematically compare the sphericities of a spherical-shaped nanoparticle made by laser ablation and a hedron-shaped nanoparticle made by chemical synthesis based on a comparison of the aspect ratios;

FIGS. 9A and 9B schematically compare the sphericities of hypothetical nanoparticles based on a comparison of the volume equivalent sphere and the surface area of the actual nanoparticle; and

FIGS. 10A and 10B are TEM images that illustrate and compare the circularities of a spherical-shaped nanoparticle made by laser ablation and a typical colloidal silver nanoparticle made by chemical synthesis

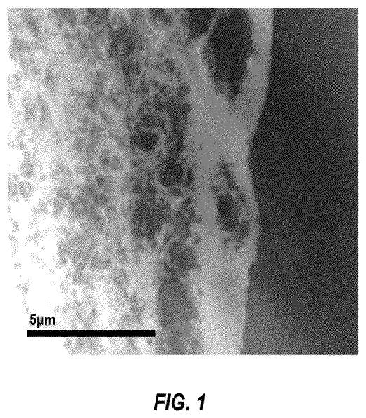

### DETAILED DESCRIPTION

### I. Introduction

Disclosed are thermoplastic polymer materials, and polymer products (e.g., medical devices) made therefrom, that incorporate metal nanoparticles. The metal nanoparticles impart antimicrobial activity to the thermoplastic polymer compositions. The polymer materials are manufactured in a manner that causes the metal nanoparticles within the interior of the polymer material to beneficially migrate to the surface of the material, where contact with microbes is more likely to occur. Resulting polymer products, such as medical devices, include a higher concentration of metal nanoparticles at the surface, where antimicrobial effects are most useful, as compared to the interior bulk.

### II. Example Nanoparticles

The term “nanoparticle” typically refers to particles having a largest dimension of less than 100 nm. Bulk materials typically have constant physical properties regardless of size, but at the nanoscale, size-dependent properties often predominate. Thus, properties of materials change as their size approaches the nanoscale and as the percentage of atoms at the surface of a material becomes significant. For bulk materials larger than one micrometer (or micron) in cross section, the percentage of atoms at the surface is insignificant in relation to the number of atoms in the bulk of the material. The interesting and sometimes unexpected properties of nanoparticles are therefore largely due to the large surface area of the material, which dominates the contributions made by the relatively small bulk of the material.

It has now been discovered that nonionic metal nanoparticles, particularly spherical-shaped silver nanoparticles, formed by laser ablation are less likely to result in antimicrobial resistance, which is unexpected given the extensive data for other silver nanoparticles. This is in contrast to colloidal silver and other silver nanoparticles made by chemical processes, which have external bond angles and facets and typically provide antimicrobial activity by releasing silver ions. When antimicrobial resistance to colloidal silver and other silver ion-releasing silver nanoparticles occurs, increasing concentrations of such nanoparticles are necessary to maintain the ability to kill microbes. However, silver ions, particularly at higher concentrations, can also be toxic to humans, mammals, fish, birds, and other higher level organisms. This limits the ability of using colloidal silver and other silver ion-releasing silver nanoparticles made using conventional means at increasingly higher concentrations.

The metal nanoparticles used in the disclosed polymer compositions are preferably nonionic, ground state, and without external edges or bond angles that cause release of metal ions. Spherical-shaped metal nanoparticles, preferably spherical-shaped silver nanoparticles, are typically used to kill microbes, although coral-shaped metal nanoparticles can provide anti-microbial activity, typically in combination with spherical metal nanoparticles. Preferred spherical-shaped metal (e.g., silver) nanoparticles have a sphericity of at least about 0.99, more preferably that approaches or equals 1.

In some embodiments, the metal nanoparticles may comprise or consist essentially of nonionic, ground state metal nanoparticles without external edges or bond angles that cause release of metal ions. Examples include spherical-shaped metal nanoparticles, coral-shaped metal nanoparticles, and blends of spherical-shaped and coral-shaped metal nanoparticles.

Conventional silver nanoparticles manufactured via chemical reduction (typically involving a capping agent such as PVP, PVA, citrate ions, or surfactants like CTAB) tend to exhibit a clustered, crystalline, faceted, and/or hedron-like shape rather than a true spherical shape with round and smooth surfaces. Such nanoparticles often cluster and can have a relatively broad size distribution. In some cases, conventional silver nanoparticles are formed as shells of silver formed over a non-metallic seed material. Colloidal silver and other nanoparticles formed by chemical and other conventional processes that are called “spherical” or “spherical-shaped” are nonetheless hedron-shaped, have external bond angles and facets, and therefore have significantly lower sphericity, such as less than 0.96, less than 0.93, or less than 0.9.

In contrast, the spherical-shaped nanoparticles that can be included in the polymer compositions disclosed herein can exhibit one or more, and preferably all, of: (1) a solid metal form, (2) a substantially unclustered form (i.e., without large agglomerates of nanoparticles, (3) a narrow size distribution (as defined below), (4) exposed/uncoated surfaces, and/or (5) smooth surface morphology. As used herein, an “exposed” or “uncoated” surface is one that omits capping agents and instead directly exposes the metal surface to the environment. And as stated above, spherical-shaped nanoparticles used in making polymer products herein preferably have a sphericity of at least 0.99, more preferably that approaches or equals 1.

The metal nanoparticles of the disclosed polymer compositions, including spherical-shaped and/or coral-shaped nanoparticles, may comprise any desired metal, mixture of metals, or metal alloy, including at least one of silver, gold, platinum, palladium, rhodium, osmium, ruthenium, rhenium, molybdenum, copper, iron, nickel, tin, beryllium, cobalt, antimony, chromium, manganese, zirconium, tin, zinc, tungsten, titanium, vanadium, lanthanum, cerium, heterogeneous mixtures thereof, or alloys thereof. Nanoparticles comprised of silver, gold, and/or mixtures and alloys thereof can be particularly effective.

Examples of metal nanoparticles and nanoparticle compositions that can be used herein are disclosed in: U.S. Pat. Nos. 9,849,512; 9,434,006; 9,919,363; 10,137,503; and 10,610,934, which are incorporated herein by reference.

Nanoparticle compositions may include spherical-shaped metal nanoparticles, coral-shaped metal nanoparticles, or a combination of the two. Spherical-shaped metal nanoparticles typically have greater antimicrobial activity, although coral-shaped metal nanoparticles can also provide anti-microbial activity and can potentiate the antimicrobial activity of spherical-shaped metal nanoparticles when the two are combined.

In some embodiments, spherical-shaped metal nanoparticles can have an average particle size (i.e., diameter) in a range of about 1 nm to about 20 nm, such as about 3 nm to about 14 nm, or about 4 nm to about 13 nm, or about 5 nm to about 12 nm, or about 6 nm to about 10 nm. In some embodiments, spherical-shaped metal nanoparticles can have a diameter of about 40 nm or less, about 35 nm or less, about 30 nm or less, about 25 nm or less, about 20 nm or less, about 15 nm or less, about 10 nm or less, about 7.5 nm or less, or about 5 nm or less. The compositions may include spherical-shaped nanoparticles having a particle size range with endpoints defined by any two of the foregoing values.

The spherical-shaped metal nanoparticles can have a particle size distribution wherein at least 99% of the metal nanoparticles have a particle size within 30% of the mean diameter, or within 20% of the mean diameter, or within 10% of the mean diameter and/or wherein at least 99% of the spherical-shaped nanoparticles have a diameter within ±3 nm of the mean diameter, or within ±2 nm of the mean diameter, or within ±1 nm of the mean diameter. The mean diameter of spherical-shaped metal nanoparticles can be determined by dynamic light scattering using intensity-weighted average.

The spherical-shaped nanoparticles can have a ξ-potential of at least about ±10 mV (absolute value), or at least about ±15 mV, or at least about ±20 mV, or at least about ±25 mV, or at least about ±30 mV.

In some embodiments, coral-shaped metal nanoparticles can be used instead of or in combination with spherical-shaped metal nanoparticles. In general, spherical-shaped metal nanoparticles can be smaller than coral-shaped metal nanoparticles and in this way can provide very high surface area for catalyzing desired reactions (e.g., antimicrobial effects) or providing other desired benefits. On the other hand, the generally larger coral-shaped nanoparticles can exhibit higher surface area per unit mass compared to spherical-shaped nanoparticles because coral-shaped nanoparticles have internal spaces and surfaces rather than a solid core and only an external surface.

In at least some cases, providing nanoparticle compositions containing both spherical-shaped and coral-shaped nanoparticles can provide synergistic results. Coral-shaped metal (e.g., gold) nanoparticles can help carry and/or potentiate the activity of spherical-shaped metal (e.g., silver) nanoparticles in addition to providing their own unique benefits. In embodiments where both spherical-shaped and coral-shaped metal nanoparticles are included in a polymer material, the mass ratio of spherical nanoparticles to coral-shaped nanoparticles in the nanoparticle composition can be in a range of about 1:1 to about 50:1, or about 2.5:1 to about 25:1, or about 5:1 to about 20:1, or about 7.5:1 to about 15:1, or about 9:1 to about 11:1, or about 10:1. The particle number ratio of spherical nanoparticles to coral-shaped nanoparticles in the nanoparticle composition can be in a range of about 10:1 to about 500:1, or about 25:1 to about 250:1, or about 50:1 to about 200:1, or about 75:1 to about 150:1, or about 90:1 to about 110:1, or about 100:1.

### III. Antimicrobial Activity

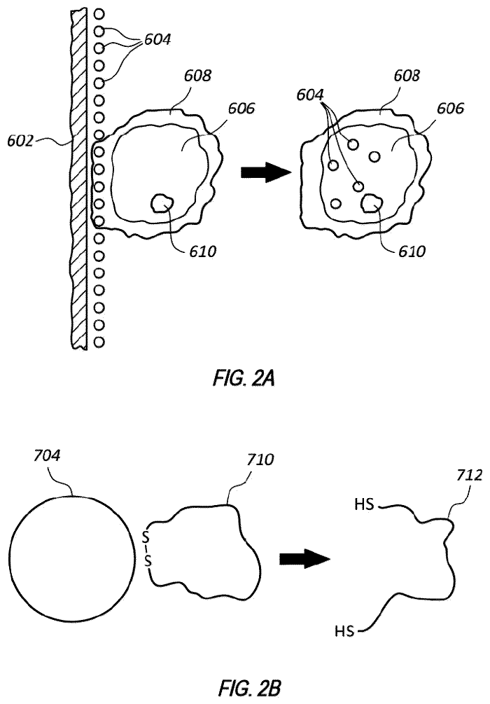

Metal nanoparticles, particularly nonionic spherical-shaped silver nanoparticle made using laser ablation as described above, can exhibit high antimicrobial activity and no long-term buildup of microbial resistance. FIGS. 2A-2B schematically illustrate a microbe after having absorbed spherical-shaped metal nanoparticle from a substrate and disulfide bonds being catalytically denatured by a spherical-shaped metal nanoparticle. FIG. 2A schematically illustrates a microbe 608 having absorbed spherical-shaped metal nanoparticles 604 from a solid substrate 602, such as by active absorption or other transport mechanism. Alternatively, spherical-shaped metal nanoparticles 604 can be provided in a composition (not shown), such as in a liquid or gel carrier. The nanoparticles 604 can freely move throughout the interior 606 of microbe 608 and come into contact with one or more vital proteins or enzymes 610 that, if denatured, will kill or disable the microbe.

One way that such metal nanoparticles may kill or denature a microbe is by catalyzing the cleavage of disulfide (S—S) bonds within a vital protein or enzyme. FIG. 2B schematically illustrates a microbe protein or enzyme 710 with disulfide bonds being catalytically denatured by an adjacent spherical-shaped nanoparticle 704 to yield denatured protein or enzyme 712. In the case of bacteria or fungi, the cleavage of disulfide bonds and/or cleavage of other chemical bonds of vital proteins or enzymes may occur within the cell interior to thereby kill the microbe in this manner. Such catalytic cleavage of disulfide (S—S) bonds is facilitated by the generally simple protein structures of microbes, in which many vital disulfide bonds are exposed and readily cleaved by nanoparticle induced catalysis.

Another potential mechanism by which metal (e.g., silver) nanoparticles can kill microbes is through the production of active oxygen species, such as peroxides, which can oxidatively cleave protein bonds, including but not limited to amide bonds.

Notwithstanding the lethal nature of nonionic metal nanoparticles relative to microbes, they have been shown to be harmless and non-toxic to humans, mammals, and animals, which contain much more complex protein structures compared to simple microbes and in which most or all vital disulfide bonds are shielded by other, more stable regions of the protein. In many cases the nonionic metal nanoparticles do not interact with or attach to human cells, other mammalian cells, or other animal cells, and can be quickly and safely expelled through the urine without damaging kidneys or other cells, tissues, or organs.

In the case of spherical-shaped silver (Ag) nanoparticles, the interaction of the silver nanoparticle(s) within a microbe has been demonstrated to be particularly lethal without the need to rely on the production of silver ions (Ag⁺) to provide the desired antimicrobial effects, as is typically the case with conventional colloidal silver compositions. The ability of spherical-shaped silver nanoparticles to provide effective microbial control without any significant or actual release of toxic silver ions (Ag⁺) into the patient or the surrounding environment is a substantial advancement in the art. Whatever amount or concentration of silver ions released by spherical-shaped silver nanoparticles, if any, is well below known or inherent toxicity levels for animals, such as mammals, birds, reptiles, fish, and amphibians.

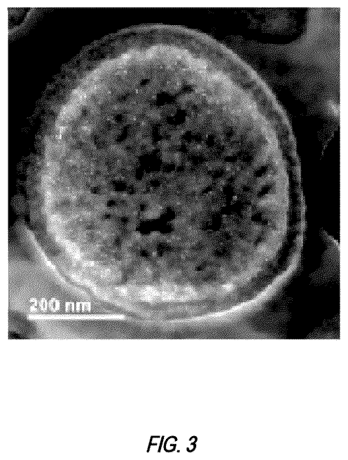

FIG. 3 illustrates a STEM image of silver (Ag) nanoparticles inside a MRSA SA62 drug resistant bacterium. The STEM image in coordination with Electron Diffraction Spectroscopy provided confirmation of disruption at sites of disulfide bonds and ferredoxins.

The use of nonionic spherical-shaped silver nanoparticles made using laser ablation provides advantages over conventional silver nanoparticles, which are known to primarily function via release of silver ions and which have been shown to lead to antimicrobial silver nanoparticle resistance. As discussed above, conventional silver nanoparticles made using chemical reduction processes are known to lead to antimicrobial resistance, meaning their effective in killing microbes diminishes over time. Some studies have shown microbial resistance to ionic silver in as few as 6 generations. Moreover, silver ions at higher concentrations can be toxic to humans, mammals, and other animals. In contrast, the spherical-shaped nanoparticles that can be included in the polymer compositions disclosed herein have been shown to have stable antimicrobial activity even after 28 passages, with no diminution of antimicrobial activity, including no significant reduction in the MIC (minimum inhibitory concentration).

### IV. Incorporating Nanoparticles into Polymers

The first step in manufacturing medical devices and other polymer products from thermoplastic polymer materials is to incorporate metal nanoparticles into a thermoplastic polymer to form an intermediate thermoplastic composition before subjecting the thermoplastic polymer to a shaping process (e.g., extrusion or injection molding). In some embodiments, a thermoplastic polymer in an appropriate form, such as thermoplastic polymer granules, can be treated (e.g., coated and/or impregnated) with metal nanoparticles (e.g., silver and/or gold nanoparticles) by providing a solution or dispersion of metal nanoparticles in a volatile solvent (e.g., water and/or organic solvent), applying the nanoparticle solution or dispersion to the thermoplastic polymer (e.g., polymer granules), optionally allowing the solvent and metal nanoparticles to penetrate into the thermoplastic polymer, and allowing the solvent to evaporate using means known in the art (e.g., through application of heat, moving dry gas, and/or reduced pressure), leaving the metal nanoparticles on and/or impregnated in the thermoplastic polymer to form an intermediate thermoplastic composition. This process can optionally be repeated one or more times to increase the concentration of metal nanoparticles in the intermediate thermoplastic composition. Other modes of incorporating metal nanoparticles into thermoplastic polymers include providing metal nanoparticles within liquid prepolymer compositions that have not fully cured, within a precursor polymer component that reacts with other prepolymer components to yield a cured thermoplastic polymer, and/or within other components (e.g., catalysts) that are added to prepolymer compositions.

Thermoplastic and other polymer materials such as those disclosed herein may be formed into a desired shape by extrusion, molding, and/or other polymer manufacturing techniques to form desired polymer products or components thereof. Polymer materials incorporating metal nanoparticles as disclosed herein are particularly useful for forming medical devices with enhanced antimicrobial activity.

Example polymer materials that may be utilized in the disclosed compositions, devices, and processes include polystyrene (PS), polyethylene (PE) (including low density polyethylene (LDPE), linear low density polyethylene (LLDPE), and high density polyethylene (HDPE)), polypropylene (PP), ethylene-vinyl acetate copolymer (EVA), polycarbonate (PC), thermoplastic polyurethane (TPU), polylactic acid (PLA), polyester (PES), polyethylene terephthalate (PET), polymethyl methacrylate (PMMA), polybutylene terephthalate (PBT), nylon/polyimide (PA), polyvinyl chloride (PVC), acrylonitrile butadiene styrene terpolymers (ABS), styrene block copolymers (SBC), medical grade thermoplastic elastomer (TPE), rubber latex (natural or synthetic), nitriles such as nitrile-butadiene rubber (NBR), other thermoplastic polymers (e.g., those suitable for medical use), and combinations thereof.

Although most examples included herein relate to thermoplastic materials, the disclosed embodiments may alternatively or additionally utilize other polymer materials, including thermoset polymers in at least some instances. Certain polymer materials that are typically understood to be thermoset polymers can in some formulations behave as thermoplastic polymers. For example, thermoplastic polyurethane (TPU) and thermoplastic polysiloxanes are thermoplastic polymers even though polyurethane and polysiloxane are often formulated as thermoset polymers.

The disclosed embodiments may additionally or alternatively include polymers that are not based on carbon or hydrocarbon chains, such as polyphosphazenes. Such polymers can be included in the bulk polymer material and/or in a coating material.

Example methods for incorporating metal nanoparticles into polymers are described in U.S. Publication No. 2024/0336755 and U.S. Publication No. 2025/0066580, which are incorporated herein by reference. Certain examples are described below.

After the metal nanoparticles are incorporated into the polymer material, the nanoparticles may be included at about 0.5 mg/kg to about 8 mg/kg, such as about 1 mg/kg, 2 mg/kg, 3 mg/kg, 4 mg/kg, 5 mg/kg, 6 mg/kg, 7 mg/kg, or a range with any combination of the foregoing values as endpoints. Preferably, the concentration of metal nanoparticles is higher at the surface portion of the finished polymer product than within the interior bulk portion, as will be discussed below.

In some embodiments, thermoplastic polymer compositions may include nanoparticles in the overall composition at a concentration of about 500 ppb to about 1000 ppm, or about 750 ppb to about 500 ppm, or about 1 ppm to about 350 ppm, or about 2 ppm to about 250 ppm, or about 4 ppm to about 200 ppm, or about 6 ppm to about 150 ppm, or about 10 ppm to 100 ppm, by weight of the polymer composition. The compositions may include nanoparticles in a concentration range with endpoints defined by any two of the foregoing values of this paragraph.

a. Application of Nanoparticles to Polymer Granules

The laser-ablation generated metal nanoparticles can be manufactured in or subsequently dispersed in liquids (e.g., water, organic solvent, and/or liquid prepolymer component) that are applied to polymer pellets/granules/beads. For example, nanoparticles formed by laser-ablation may be dispersed in water and/or an organic solvent, such as ethanol, isopropyl alcohol, acetone, ethyl acetate, toluene, xylene, and other volatile organic solvents that can be applied to polymer granules prior to an extrusion or injection molding process. Although water can be utilized in the nanoparticle solution, many polymer granules are somewhat hygroscopic and readily absorb water, which is typically undesirable. Thus, the nanoparticle-containing liquid may omit water if necessary.

Liquid media applied to polymer compositions (such as granules or liquid precursor compositions) or applied to formed polymer products (such as during quenching in a cooling bath or as an etchant) may include nanoparticles at a concentration of about 500 ppb to about 2000 ppm, or about 750 ppb to about 1500 ppm, or about 1 ppm to about 1200 ppm, or about 2 ppm to about 1000 ppm, or about 4 ppm to about 750 ppm, or about 6 ppm to about 500 ppm, or about 10 ppm to 250 ppm, by weight of the liquid medium applied to the polymer composition. Concentration ranges using any combination of the foregoing as endpoints may also be utilized.

It will be understood that the concentration of nanoparticles in the liquid media does not necessarily determine the concentration of nanoparticles in the polymer compositions, which can have a higher concentration of nanoparticles (e.g., because the removal of volatile solvent in the liquid media and from the mixture of liquid media and polymer composition, and by repeating the process, may result in a higher concentration of nanoparticles in the polymer composition.

The nanoparticle solution or dispersion can be applied to the polymer granules in any suitable manner, such as by spray application or by adding both the liquid and the polymer granules to the same container. In embodiments in which the nanoparticle solution is sprayed onto polymer granules, the granules may be placed on a conveyor system on which they are sprayed. Spray application may also be accomplished using a cyclonic chamber, optionally with thermal enhancements to aid in driving off the liquid.

Following application, the volatile solvent of nanoparticle solution or dispersion may be evaporated from the granules, thereby removing the solvent and leaving the nanoparticles deposited on the polymer granules. This may be accelerated via the application of heat (e.g., infrared, microwave, thermal convention using an inert gas (e.g., nitrogen or argon), or thermal conduction) and/or vacuum. This is preferably performed in an inert gas unless the associated solvents are safely nonflammable. This process can be repeated one or more times to further increase the concentration of metal nanoparticles in the polymer granules. Alternatively, or in addition, the nanoparticle-treated polymer granules can be melted and reformed into new polymer granules, which are then treated one or more times with the nanoparticle solution or dispersion to further increase the concentration of metal nanoparticles in the polymer granules. This process can also be repeated to further increase the concentration of metal nanoparticles in the polymer granules. The nanoparticle-treated polymer granules are an example of an intermediate thermoplastic composition that can be heated to a molten state and shaped using an appropriate shaping process, such as extrusion or injection molding.

The treated polymer granules can be heated to a molten state and used in extrusion, injection molding, or other plastics manufacturing processes to generate polymer products. The end polymer-based product will contain a dispersion of nanoparticles throughout the bulk of the associated polymer portions of the product. For example, tubing made from the molten polymer would contain a uniform distribution of nanoparticles thereby enabling antimicrobial and/or UV protective effects.

Centrifuge systems, including batch mode and flow centrifuge systems, may be utilized to apply nanoparticles from a nanoparticle solution or dispersion to polymer granules. At sufficient speed (e.g., 10,000 rpm), the centrifuge can force metal nanoparticles to the location of the polymer granules. The higher concentrations at regions of the centrifuge enable increased uptake of nanoparticles by the polymer granules, providing deeper penetration of nanoparticles into the bulk polymer in addition to surface adsorption. This can be beneficial in applications where including nanoparticles in sub-surface layers of the resulting polymer material is desired.

b. Application of Nanoparticles to Liquid Compositions

Nanoparticles can additionally or alternatively be incorporated into polymer compositions by directly mixing a nanoparticle solution or dispersion with a liquid composition (e.g., a latex emulsion or other emulsion, a polymer suspension, or a prepolymer) that has not fully cured or otherwise been formed into a solid polymer product. The nanoparticle mixture may include a solvent, so long as the solvent is not significantly destructive to the components of the liquid polymer composition (e.g., the monomer/oligomer materials) and so long as the solvent is significantly more volatile than the liquid polymer or prepolymer composition. After mixing, the solvent can be evaporated, leaving the liquid polymer or prepolymer composition inclusive of the nanoparticles.

Nanoparticles can additionally or alternatively be incorporated into polymer or prepolymer compositions by mixing the nanoparticles with a precursor polymer component such as polyethylene glycol (PEG) that is added to a liquid polymer composition to be further processed/formed. One or more of such precursor polymer components may include nanoparticles, so long as they are used in volumes sufficient to incorporation the desired concentration of nanoparticles and are capable of functioning as carriers for the nanoparticles prior to mixing with the remaining polymer composition components.

Examples of monomers and/or additives that used as liquid carriers for metal nanoparticles prior to being used to form polymers include, but are not limited to, diols (ethylene glycol, propylene glycol, 1,3-butanediol, 1,4-butanediol (BDO), 1,5-pentanediol, 1,6-hexanediol, polyether glycols, other glycols and diols, e.g., up to 20 carbons or more in length), triols, other polyols (e.g., polyether polyols and polyester polyols) for reaction with isocyanates to make polyurethanes or diacids to make polyesters, isocyanates (e.g., methylene diphenyl diisocyanate (MDI), toluene diisocyanate (TDI), hexamethylene diisocyanate (HDI), isophorone diisocyanate (IPDI), 1,6-hexamethylene diisocyanate (HDI) used to make polyurethanes), dicarboxylic acids to make polyesters or polyamides (e.g., terephthalic acid, adipic acid, and the like), diamines (e.g., to make polyamides), alkenes (e.g., to make polyolefins) and derivatives (e.g., fluorinated alkenes for Teflon, vinyl chloride for polyvinyl chloride, styrene for polystyrene), dienes (e.g., butadiene, isoprene), epoxides (e.g., to make epoxies), bisphenol A (BPA) (e.g., to make polycarbonates), acrylates, methacrylates, acrylonitriles, silanes (e.g., to make polysiloxanes), ketones (e.g., to make polyetheretherketones), phosphazene (e.g., to make polyphosphazenes), chain extenders (e.g. 1,4 butanediol, 1,6 hexanediol, aliphatic diamines (e.g., ethylenediamine (EDA)), aromatic diamines (e.g., 1,4 diaminobenzene, p-phenylenediamine), and cross-linkers.

Metal nanoparticles can additionally or alternatively be mixed with catalysts (e.g., dibutyltin dilaurate), stabilizers, antioxidants, UV stabilizers, and biocompatible additives used in making polymers.

In some embodiments, a precursor liquid comprising monomers and/or additives for use in forming the polymer can be used in the laser ablation process. That is, a precursor liquid can function as the carrier medium in which the generated nanoparticles are formed during the laser ablation process. A precursor liquid can be used in this manner so long as the laser can sufficiently pass through the medium to the underlying bulk metal material to be ablated.

When the liquid polymer or prepolymer composition has been processed to form a solid thermoplastic polymer incorporating metal nanoparticles, it is then another example of an intermediate thermoplastic composition (i.e., as an alternative to nanoparticle treated polymer granules).

c. Quenching

Nanoparticles can additionally or alternatively be incorporated into polymer compositions by mixing the nanoparticles with a quenching medium (e.g., solvent, water, or reactive agent, e.g., 1,4-butanediol, that can react with the polymer surface) applied to the polymer composition (e.g., following extrusion or injection molding). Metal nanoparticles of sizes below about 40 nm are impacted by temperature gradients and tend to move toward colder, less energetic regions of a mixture. This can be utilized to concentrate the nanoparticles toward the surface of the resulting polymer product relative to the bulk, as discussed in greater detail herein.

### V. Concentrating Nanoparticles at the Polymer Surface

The intermediate thermoplastic composition containing metal nanoparticles can be formed into a polymer product by an appropriate shaping process, such as by extrusion or injection molding. When the intermediate thermoplastic composition is heated into a molten state as part of the shaping process (e.g., within a forming apparatus, such as an auger, extruder, or injection molding machine), the metal nanoparticles become distributed throughout the molten thermoplastic polymer. In some embodiments, the molten thermoplastic polymer composition can be mixed, such as by an auger or other mixer, to cause the metal nanoparticles to be substantially homogeneously dispersed throughout the molten thermoplastic polymer composition prior to shaping. The molten thermoplastic polymer composition is formed into a desired shape of an intermediate polymer product (e.g., by extrusion or injection molding). As this point, the metal nanoparticles may be substantially evenly distributed throughout the intermediate polymer product, which is then cooled using appropriate cooling means, such as a cooling bath, in a manner that causes the nanoparticles to be more concentrated at the surface.

In some embodiments, the intermediate polymer product is cooled in a controlled manner that causes the metal nanoparticles to migrate to the surface so as to an have a higher concentration at the surface portion than in the interior bulk portion of the thermoplastic polymer material of the polymer product. In some embodiments, the surface portion can be understood to be the outer 100 nm of the thermoplastic polymer (i.e., the cross-sectional thickness of the surface portion). The distribution of metal nanoparticles in the polymer product is dependent on how the intermediate polymer product is cooled, with the metal nanoparticles apparent being drawn to the surface if the thermoplastic polymer is cooled slowly and in a controlled manner.

In general, it has been found that metal nanoparticles can migrate toward cooler regions of a thermoplastic polymer as long as it remains sufficiently soft or molten to permit movement of metal nanoparticles therein. During controlled cooling, the metal nanoparticles can migrate toward the cooler region at the surface, with there being a balance between the temperature and rate of cooling because once the polymer surface portion has solidified, the metal nanoparticles can no longer migrate but become frozen in place.

Polymer materials can be manufactured such that the concentration of nanoparticles in the surface portion is higher than in the interior bulk portion of the material. For example, a catheter or other tubular medical device having outer and inner surfaces can be manufactured such that the concentration of metal nanoparticles at the inner surface and/or outer surface is higher than the concentration of metal nanoparticles in the interior middle portion of the catheter or other tubular wall. Polymer materials intended to exhibit antimicrobial properties benefit from providing antimicrobial activity at the surface, where contact with microbes is more likely to occur. Thus, a higher concentration of antimicrobial nanoparticles at the surface of the polymer material can efficiently enhance the overall antimicrobial efficacy of the polymer material more directly than simply increasing the overall concentration of nanoparticles within the overall material, including the interior bulk portion.

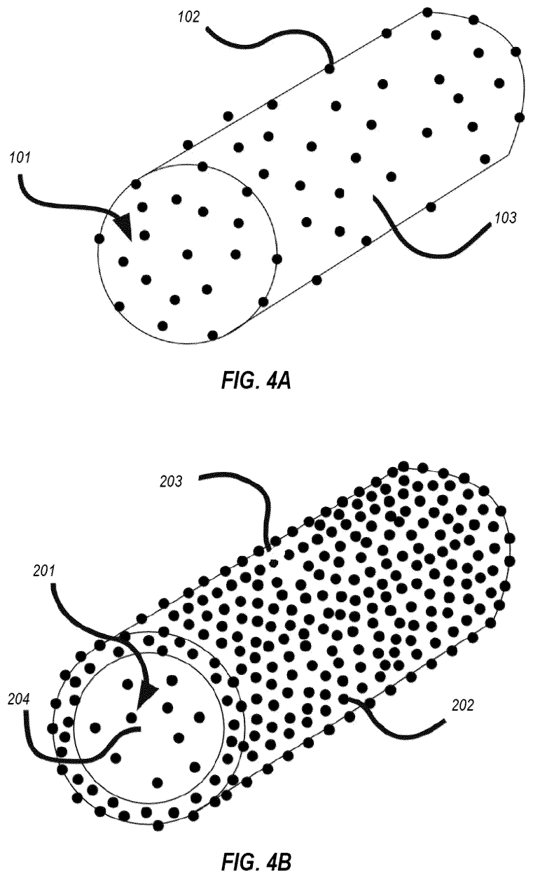

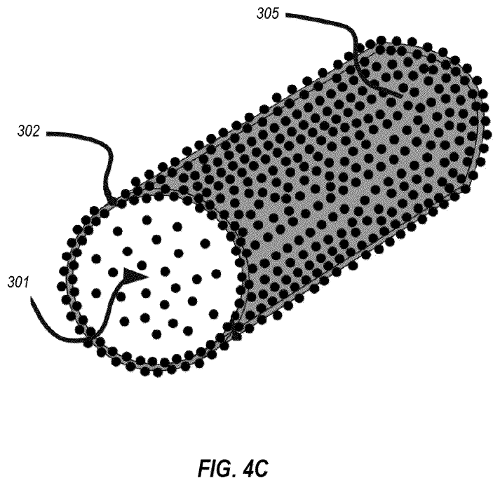

FIG. 4A illustrates a polymer material 101 with metal nanoparticles 102 that are substantially evenly distributed throughout the bulk portion of the polymer material and on the surface 103 of the material. The polymer material 101 can be formed and can incorporate nanoparticles using the processes disclosed herein. The polymer material 101 can be synthesized into a solid that is then processed into granules/pellets that are usable in further processes (e.g., extruding and molding) to form a desired polymer product (e.g., a medical device or component thereof).

To achieve sufficient antimicrobial ability on the surface of the final polymer product, the nanoparticle concentration should be high enough at the surface to affect bacteria that contact that surface. Antimicrobial effects are typically seen with metal nanoparticle concentrations/densities beginning about 0.5 mg/L (0.5 mg/kg) and increasing in efficacy up to and beyond about 15 mg/L (15 mg/kg). Such concentrations/densities are advantageous at the point of the microbial interface with the polymer material. In many instances, even if there is overall a sufficient level of nanoparticles in the polymer material, the distribution of the nanoparticles can leave insufficient concentrations at the surface of the material where contact with microbes is most common.

FIG. 4B illustrates a polymer material 201 with an increased concentration of metal nanoparticles 202 at the surface 203 relative to the inner bulk 204 of the polymer material 201. In some embodiments, the inner bulk 204 can incorporate metal nanoparticles within antimicrobial concentrations but less than at the surface 203 of the polymer material 201.

A polymer material with surface-concentrated nanoparticles can be achieved using (1) a controlled cooling process, (2) a metal nanoparticle bath process, (3) an annealing process, (4) an etching process, or combination thereof.

In some embodiments, the concentration of metal nanoparticles in the surface portion of a polymer material can be up to about 10 times, up to about 8 times, up to about 6 times, up to about 5 times, or up to about 4 times, greater than the concentration of the metal nanoparticles within the interior bulk portion of the polymer material, such as between about 1.5 times to about 10 times greater than the concentration of the metal nanoparticles within the interior bulk portion. The surface portion can be is an outer 100 nm of the thermoplastic polymer of the polymer material incorporating nanoparticles.

To provide a desired level of antimicrobial activity, the metal nanoparticles can be included in at least the surface portion of the polymer material at a concentration of about 2 ppm to about 2000 ppm, or about 10 ppm to about 1400 ppm, or about 20 ppm to about 1000, or about 30 ppm to about 500 ppm, or about 50 ppm to about 250 ppm, or about 70 ppm to about 150 ppm. It has been determined, for example, that a polymer material that has a concentration of spherical-shaped silver nanoparticles of 70 ppm can result in a 4 log reduction in bacteria or other microbes.

a. Controlled Cooling

In some embodiments, such as in the case of a continuously extruded intermediate polymer product, controlled cooling can be performed using a larger cooling bath at a warmer temperature than is otherwise common in the industry (e.g., a trough that is 12 feet long). Alternatively, controlled cooling can be performed using multiple cooling baths (e.g., two) that are progressively cooler. In still other embodiments, controlled cooling may be performed by providing a time delay (e.g., 5 seconds) between extrusion or demolding and when the intermediate extruded or demolded polymer product is placed in a cooling bath. Such delayed or controlled cooling permits the surface portion to be somewhat cooler than the interior bulk portion of the thermoplastic polymer, which draws the metal nanoparticles toward the cooler surface as long as the surface is not cooled so rapidly that it becomes solid or rigid too soon, which prevents migration of the metal nanoparticles toward the surface. In some embodiments, the cooling bath may contain metal nanoparticles that can become embedded within, and further increase the concentration of metal nanoparticles in, the surface portion of the thermoplastic polymer.

In one example of a controlled cooling process, a heated polymer material with embedded nanoparticles (e.g., formed using methods described herein) is placed in a bath that is below the extrusion/molding temperature of the polymer material to enable cooling and solidification of the polymer material but not so cool as to cause overly rapid cooling. It has been found that overly rapid cooling can cause premature solidification of the surface of the polymer material, which prevents migration of nanoparticles to the surface and thereby limits the concentration of nanoparticles at the surface. On the other hand, if cooling is sufficiently controlled, the resulting thermal gradients cause the metal nanoparticles to migrate and concentrate at the surface of the polymer material before the surface solidifies.

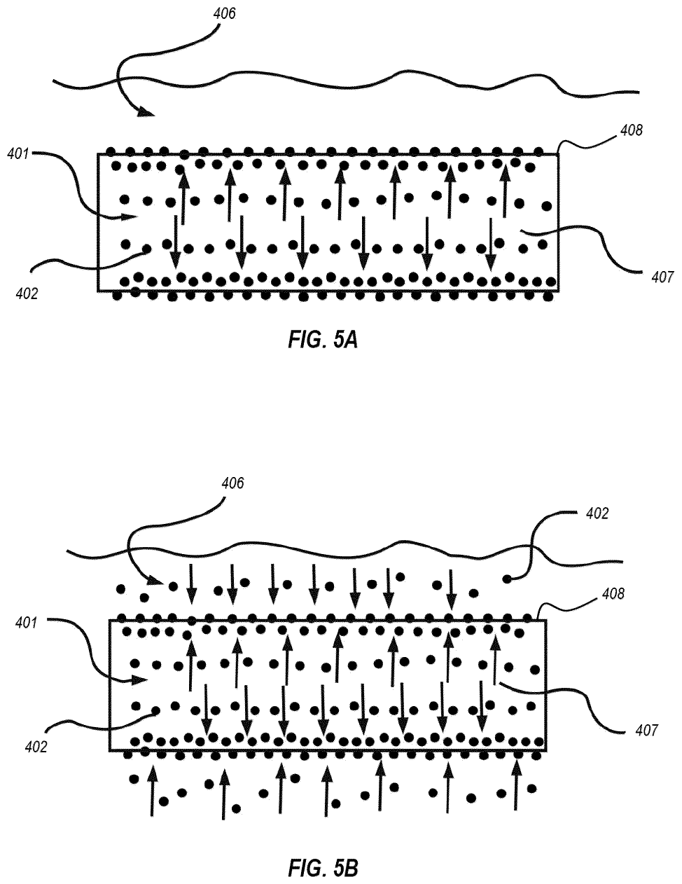

FIGS. 5A and 5B illustrate methods for increasing metal nanoparticle concentration at the surface using a cooling bath for controlled cooling. FIGS. 5A and 5B are cross-sectional views of a polymer material 401 with incorporated metal nanoparticles 402, placed within a quenching bath 406.

The temperature at the center 407 of the polymer material 401 is higher than at the surface 408 of the polymer material 401. Initially, the metal nanoparticles 402 can be evenly distributed throughout the polymer material 401. When the ΔT between the quenching fluid 406 and the thermoplastic material 401 is within an appropriate range, the thermal gradient between the hotter polymer center 407 and the cooler polymer surface 408 causes migration of the metal nanoparticles 402 to the polymer surface 408. If the ΔT is not so high as to cause overly rapid solidification near the polymer surface 408, the concentration of metal nanoparticles 402 at the surface 408 is beneficially increased.

FIG. 5B is similar to FIG. 5A but the quenching bath 406 further includes metal nanoparticles 402 that can provide additional metal nanoparticles at the surface of the polymer material 401. Including nanoparticles in the cooling bath can promote the migration of nanoparticles from the bath onto the polymer surface to further increase the concentration of metal nanoparticles at the polymer surface. The concentration of metal nanoparticles in the cooling bath may affect how and to what extent the metal nanoparticles are able to collect at and penetrate somewhat into the polymer surface. Increasing the concentrations of metal nanoparticles would be expected to increase the quantity and concentration of metal nanoparticles at or in the polymer surface (i.e., the outer 100 nm of the polymer material).

The temperature of the polymer (T_{polymer}) shortly after exiting the mold or extruder is often about 300° F. to about 350° F. It has been found that a bath temperature (T_{bath}) of about 60° F. or more, such as about 70° F. or more, 80° F. or more, 90° F. or more, 100° F. or more, 110° F. or more, or up to about 120° F., enables effective migration of metal nanoparticles from the interior bulk portion of the material to the surface portion without causing overly rapid solidification of the surface portion of the polymer. T_{bath} ranges using any two of the foregoing values as endpoints may also be used. Presently preferred bath temperatures, in at least some applications, have a T_{bath} in a range of about 70° F. to about 100° F., such as about 80° F. to about 90° F. While higher temperatures may be useful in some applications, the higher temperatures can slow the overall manufacturing process and/or can lead to deformities in the polymer product structure. The foregoing preferred ranges typically balance the competing effects by enabling effective concentration of nanoparticles at the polymer material surface without overly disrupting manufacturing times or harming product structure.

In some embodiments, the difference in temperature (ΔT) between T_{polymer} and T_{bath} is about 290° F. or less, such as about 275° F. or less, or 260° F. or less, or 245° F. or less, or 230° F. or less, or 205° F. or less, or 190° F. or less, or a range using any combination of the foregoing values as endpoints. Such ΔT values have been found to effectively enable concentration of metal nanoparticles at the surface portion of the polymer material without overly disrupting manufacturing times or harming product structure. Some presently preferred embodiments use a ΔT of about 200° F. to about 270° F.

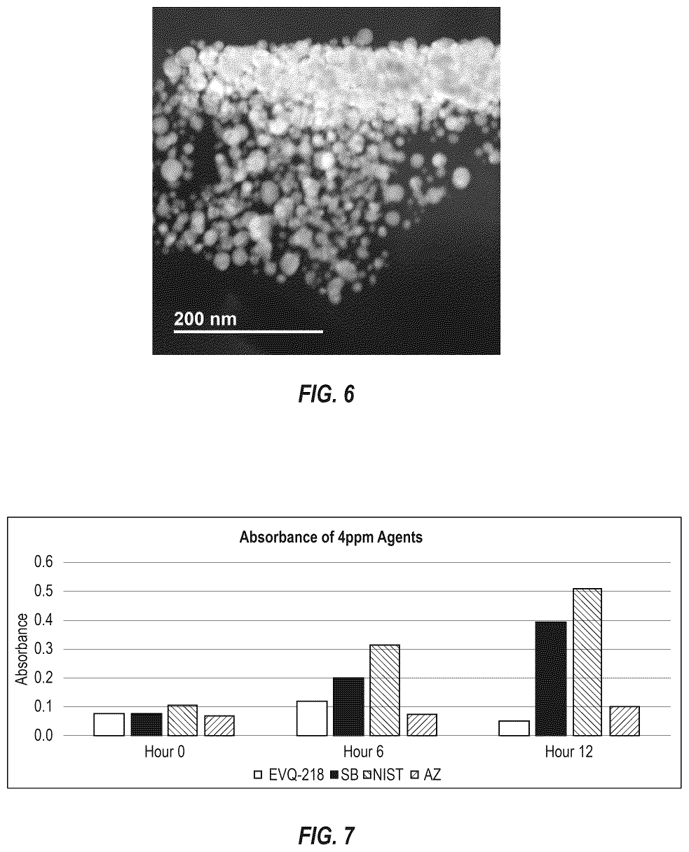

FIG. 6 is a STEM image of a thermoplastic material subjected to extrusion followed by a controlled cooling bath as described herein. As visible in the image, the controlled temperature gradient caused an accumulation of metal nanoparticles at the surface of the thermoplastic material.

b. Annealing

The polymer material can additionally or alternatively undergo an annealing process to concentrate nanoparticles at the polymer surface. A formed polymer product can be heated to a temperature below the melting temperature of the polymer but exhibiting some liquid-like behavior on the surface. Subsequent cooling of the product can cause nanoparticles to migrate from the interior bulk portion to the surface portion. Suitable annealing temperatures can vary depending on the particular thermoplastic used. Such temperatures are known to those of skill in the art and/or can be readily obtained in standard publications and references. By way of example, a suitable annealing temperature may be between the glass transition temperature and the melting point of the thermoplastic polymer, such as 5° F. below the melting point, 10° F. below the melting point, 15° F. below the melting point, or 20° F. below the melting point, or within a range bounded by any two of the foregoing temperature differentials.

Annealing can additionally be implemented to redistribute metal nanoparticles and expose even more at the surface 408 (See FIGS. 5A and 5B). Even if the ΔT between the molding temperature and cooling bath is tailored to cause or allow migration of metal nanoparticles 402 to the surface 408 before excessive solidification at the surface 408 has occurred, annealing can be advantageous to further increase the number and/or concentration of metal nanoparticles 402 that are sufficiently exposed at the surface and available for contributing to antimicrobial effects.

c. Etching

The polymer material can additionally or alternatively undergo an etching process to concentrate nanoparticles at the polymer surface. Etching can beneficially expose nanoparticles that are just below the polymer surface. Etching can be carried out using chemical or physical means. In the case of a chemical etchant, nanoparticles may also be included in the etchant to further assist in delivering nanoparticles to the polymer surface. Thus, even if the ΔT is tailored to allow migration of metal nanoparticles 402 to the surface 408 before excessive solidification at the surface 408 has occurred, etching can be advantageous to further increase the number and/or concentration of metal nanoparticles 402 that are sufficiently exposed at the surface and available for contributing to antimicrobial effects.

d. Nanoparticle Coatings

FIG. 4C illustrates a polymer material 301 with metal nanoparticles 302 substantially evenly distributed throughout. In addition, a coating 305 is applied to the polymer material 301. The coating 305 can be of a different polymer chemistry than the polymer material 301 forming the interior bulk of the product. In addition to polymers disclosed above or polymers known in the art that can be used to make polymer products, the coating may include hyaluronic acid or a methyl silicate. The coating 305 preferably includes a concentration of nanoparticles that is higher than the concentration of nanoparticles in the polymer material 301. The metal nanoparticles 302 can be incorporated into the coating 305 using any of the methods described herein for incorporating nanoparticles into polymer materials. For example, the coating 305 could incorporate metal nanoparticles 302 during synthesis and/or metal nanoparticles 302 can be applied along with or onto the coating using a soak or spray method. In some embodiments, the nanoparticle 305 coating can be selected or formulated to provide increased lubricity of the polymer surface.

The nanoparticle coating can also be applied in the form of a mold release agent in cases where the polymer material is formed into a desired shape by injection molding or other molding process. The injection molded polymer material may contain an initial concentration of nanoparticles relatively evenly distributed throughout the polymer. The use of a mold release agent, such as PTFE or oil-based materials, containing nanoparticles can apply an additional quantity of nanoparticles at or in the polymer surface.

### VI. Example Medical Devices

Polymer materials manufactured using one or more of the methods disclosed herein can include medical devices. The metal nanoparticles incorporated into the medical device are capable of deactivating or killing microbes, preventing microbial growth on or inside the medical devices. This beneficially prolongs the use of the devices in environments such as hospitals or clinics. This also benefits sterilization of the products, leading to lower costs in storage and sterilization procedures.

Examples of medical devices that may be formed, at least in part, using the methods disclosed herein include, but are not limited to, gloves (e.g., latex gloves), catheters, wound dressings, syringes and other drug delivery components, adhesives, tapes, and polymeric portions of implantable devices (e.g., polymeric portions of pacemakers, replacement joints, drug pumps, intrauterine devices (IUDs), cochlear implants, vascular access devices, artificial heart valves).

### VII. Working Examples

### a. Example 1—Accumulation of Metal Nanoparticles at the Polymer Surface

As discussed above, FIG. 6 is a STEM image of a thermoplastic material subjected to extrusion followed by a controlled cooling bath as described herein. The colling bath was maintained at a temperature in a range of 70° F. to 100° F. and was able to provide controlled and slower cooling of the extruded thermoplastic material compared to conventional quench baths at lower temperatures, which permitted or caused the embedded metal nanoparticles to migrate to the polymer surface. The STEM image confirms that the controlled temperature gradient caused an accumulation of metal nanoparticles at the surface of the thermoplastic material as proposed in the disclosure.

### b. Example 2—Efficacy Against Biofilms

The unique ability of the metal nanoparticles (i.e., spherical-shaped silver nanoparticles) disclosed herein (formed from laser ablation, that are uncoated and without capping agents, and with a narrow size distribution) to resist agglomeration, to provide antimicrobial efficacy without the release of metal ions, and to be manufactured in an uncoated state (thereby avoiding complex surface morphologies), allow the nanoparticles to penetrate and reach bacteria within biofilms, where conventional antibiotics and other nanoparticle systems (based on metal ion release) have significant limitations. The growth of biofilms can be of particular concern for medical devices such as catheters, with biofilms exhibiting higher resistance to conventional antibiotics and silver ions than planktonic bacteria.

Pseudomonas aeruginosa (ATCC 15442) was grown in cationic Mueller Hinton broth (CMHB) in several wells of a 96 well plate. A 96-peg lid was placed on the plate to bring the pegs into contact with respective wells. See, e.g., T. Tsukatani, F. Sakata, R. Kuroda, “A rapid and simple measurement method for biofilm formation inhibitory activity using 96-pin microtiter plate lids”, World J. Microbiol. Biotechnol., 2020, doi:10.1007/s11274-020-02964-6.

After a first growth period of 20 hours (temperature=34° C.) to induce creation of biofilms, the peg lid was removed and rinsed three times with a wash solution, leaving biofilms on the peg surfaces. The 96-peg lid was then transferred to a 96-well plate with fresh CMHB media. Different wells also included different treatments, each provided at 4 ppm:
(1) EVQ-218: spherical, nonionic silver nanoparticles formed by laser ablation and that are uncoated (no capping agents required for manufacture); particle size in a narrow size distribution between 8 nm to 12 nm.
(2) SB: a colloidal silver product (SB22299) available from Silver Biotics (American Fork, UT), determined to be silver nanoparticles formed from a process using a silver electrode in a reducing/capping salt, with average size of approximately 10 nm though mostly present in ˜50 nm agglomerates.
(3) NIST: standard nanoparticle composition for the National Institute of Standards and Technology (NIST), available from nanoComposix (San Diego, CA); formed through a chemical reduction process with reducing/capping agents and known to release silver ions; average size of approximately 10 nm, but with a broader particle size distribution.
(4) AZ: Azithromycin, used as a positive control.

The pegs were contacted with the nanoparticle treatments for a treatment period of 20 hours, after which the 96-peg lid was removed, rinsed three times with a wash solution, and transferred to a 96-well plate containing fresh CMHB media. Growth in the media of the wells was monitored with a plate spectrometry reader (TECAN F200) at 595 nm. Higher absorbance in the measured media is indicative of greater bacterial survival within the biofilms, whereas lower absorbance is indicative of greater efficacy of the treatment (i.e., greater ability of the nanoparticle treatment to penetrate the biofilm and inhibit the bacteria.

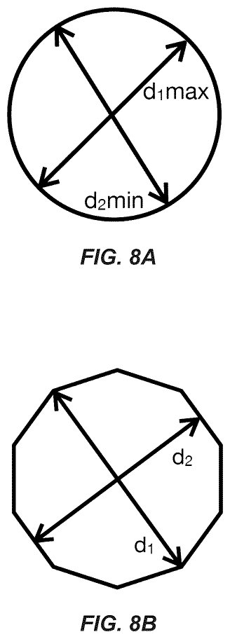

Results are illustrated in FIG. 7. As shown, the EVQ-218 nanoparticles were able to prevent increases in absorbance across the 12 hour measurement period, on par with the azithromycin positive control, indicating that the EVQ-218 nanoparticles were able to effectively penetrate the biofilm and inhibit the bacteria within the film. The comparison nanoparticle treatments (SB and NIST) did not show such efficacy, and were instead associated with an increase in bacterial growth in the media, indicating that these treatments did not significantly penetrate the formed biofilms.

This surprising difference in efficacy illustrates that nonionic, spherical-shaped silver nanoparticles that are uncoated and do not operate through the release of silver ions can indeed effectively penetrate biofilms to kill bacteria within and underneath the films, whereas the other types of nanoparticles failed to effectively prevent re-inoculation of media by the biofilms.

### c. Example 3—Antibiotic Resistance

In addition to the known fact that bacteria can develop resistance to antibiotic drugs, reducing or eliminating their effectiveness, there is a growing body of evidence showing that bacteria can also develop resistance to conventional colloidal silver and silver nanoparticles made by chemical synthesis. (See McNeilly, et al., “Emerging Concern for Silver Nanoparticle Resistance in Acinetobacter baumannii and Other Bacteria,” Frontiers in Microbiology April 2021|Volume 12|Article 652863; Panáček, et al., “Bacterial resistance to silver nanoparticles and how to overcome it,” Nature Nanotechnology|Vol 13|January 2018|65-71; Hosny, et al., “The increasing threat of silver-resistance in clinical isolates from wounds and burns,” Infection and Drug Resistance 2019:12 1985-2001).

In contrast, the silver EVQ-218 nanoparticles used in Example 2 were subjected to serial passage testing and did not show signs of generating resistance even after 28 passages.

The serial passage testing was independently carried out on Pseudomonas aeruginosa (ATCC 15442) and Escherichia coli (ATCC 25922), each at two silver nanoparticle concentrations (4.75 ppm and 2 ppm). The bacteria were streaked onto tryptic soy agar (TSA) plates and incubated overnight at 37° C. Subsequently, 10 ml containers with Mueller Hinton broth and silver nanoparticle solution (silver broth mixture) were inoculated, with final concentration of silver nanoparticles set to 4.75 ppm or 2 ppm. The containers were incubated at 37° C. and 250 RPM for 24 to 36 hours and monitored for growth, after which serial passage was performed by inoculating fresh silver broth mixture. Every 5-7 days, the most recent cultures were streaked onto fresh TSA plates to determine whether resistance had been generated. No measurable resistance was determined even after 28 passages.

### VIII. Sphericity

The spherical-shaped metal nanoparticles disclosed herein are characterize as having high sphericity, approaching or equaling a sphericity of 1, which defines a perfect sphere. Sphericity can affect how metal nanoparticles behave, particularly when the particle size is below about 20 nm. The changes in behavior of metal nanoparticles below about 20 nm differ depending on morphology, such that the behavior of a quasi sphere or a facetted sphere is different than that of a smooth sphere. This can be seen in zeta potential differences due to point charges where facets meet and chemical interaction with surface area. Also, plasmon resonance can be affected by irregular shapes in comparison to round smooth spheres.

To illustrate the geometric differences between spherical shaped metal nanoparticles (e.g., EVQ-218 nano spheres, which are available from Evoq Nano, located in Salt Lake City, Utah) and equivalent synthesized silver nano colloids, reference is made to math and imaging data below. One way to determine the sphericity of a nanoparticle is to determine the ratio of surface morphology by its maximum diameter and minimum diameter. While Transmission Electron Microscopy (TEM) only shows two dimensions of the nanoparticles, the ratio of the maximum and minimum diameters of a metal nanoparticle is one way to determine its sphericity.

Reference is made to FIGS. 8A and 8B, which compare the ratios of the maximum and minimum diameters of a spherical metal nanoparticle and a faceted, quasi spherical metal nanoparticle. FIG. 8A schematically illustrates the maximum diameter (d₁max) and minimum diameter (d₂ min) of a smooth spherical-shaped metal nanoparticle. In this case, the maximum and minimum diameters are the same, with an aspect ratio of 1:1 or 100% sphericity (d1=d2), (sphericity of 1). FIG. 8B schematically illustrates the maximum diameter (d₁max) and minimum diameter (d₂ min) of a faceted, quasi spherical metal nanoparticle. In this case, the maximum and minimum diameters are not the same. Instead, the maximum diameter (d₁) is larger than the minimum diameter (d₂), such that the aspect ratio is greater than 1 (d1>d2). In this case, the aspect ratio is 1:0.94 or a sphericity of 0.94.

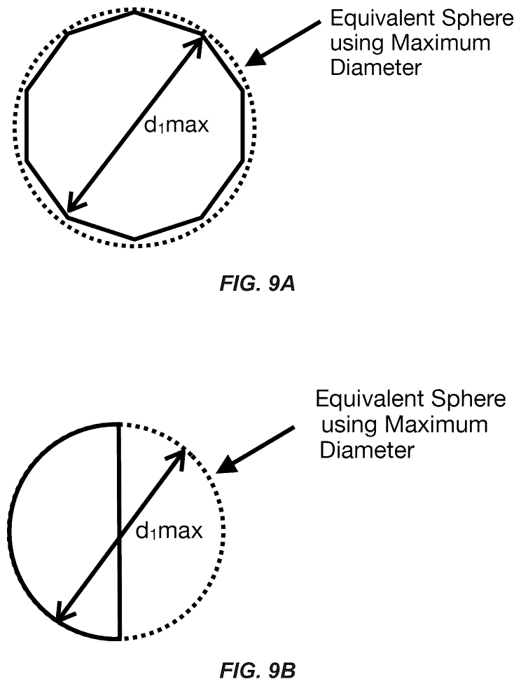

Reference is made to FIGS. 9A and 9B, which illustrate sphericity in terms of the volume equivalent of a sphere with the surface area of the actual particle. In a perfect sphere, this ratio again is 1:1, which equates to a sphericity of 1. However, in an irregular or quasi sphere, they are not equal. FIG. 9A schematically illustrates a hedron-shaped quasi spherical nanoparticle in which the maximum diameter (d₁max) of the nanoparticle is equal to the diameter of the circumscribing sphere but where the facets do not extend to circumference such that the nanoparticle has a sphericity of less than 1. FIG. 9B schematically illustrates an extreme example of a smooth nanoparticle hemisphere with a low sphericity that is half the volume sphere, or a sphericity of 0.5.

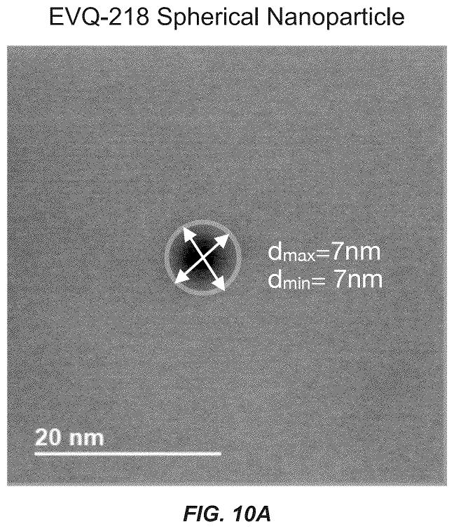

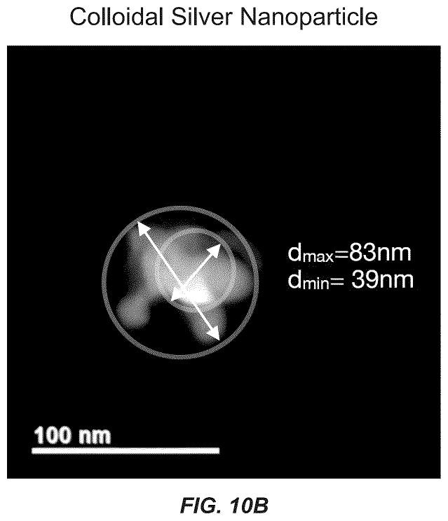

Reference is made to FIGS. 10A and 10B, which are TEM images that illustrate and compare the 2-dimensional circularities of a spherical-shaped nanoparticle made by laser ablation and a typical colloidal silver nanoparticle made by chemical synthesis. Circularity is similar to the ratios discussed above relative to FIGS. 8A-8B and 9A-9B, but based on the square root of the diameter aspect ratio (dmax/dmin)^{1/2}. FIG. 10A is a TEM image of a spherical-shaped EVQ-218 silver nanoparticle, which has a maximum diameter of 7 nm (dmax=7 nm) and minimum diameter of 7 nm (dmin=7 nm). The aspect ratio is therefore 1, with the sphericity being 1 and the circularity also being 1. Thus, spherical-shaped metal nanoparticles made by laser ablation as disclosed herein have a very high sphericity that approaches or equals 1, a high circularity that approaches or equals 1, and an aspect ratio that approaches or equals 1. FIG. 10B, by contrast, is a TEM image of a typical colloidal silver nanoparticle made by chemical synthesis, which has a maximum diameter of 83 nm (dmax=83 nm) and a minimum diameter of 39 nm (dmin=39 nm). The colloidal silver nanoparticle has a sphericity that is complex due to irregular morphology. However, the aspect ratio, which is the inverse of sphericity, is 89 nm/39 nm (or 2.28) and the square root of the aspect ratio, which is the inverse of circularity, is 1.51.

### IX. Additional Terms & Definitions

Mean particle sizes disclosed herein, unless clearly indicated otherwise, represent intensity-weighted mean hydrodynamic diameters (also known as the z-average), as determined using dynamic light scattering (DLS). See, for example, ISO 13321.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

The various features of a given embodiment can be combined with and/or incorporated into other embodiments disclosed herein. Thus, disclosure of certain features relative to a specific embodiment of the present disclosure should not be construed as limiting application or inclusion of said features to the specific embodiment. Rather, it will be appreciated that other embodiments can also include such features.

In addition, unless otherwise indicated, numbers expressing quantities, constituents, distances, or other measurements used in the specification and claims are to be understood as optionally being modified by the term “about.” When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

The embodiments disclosed herein should be understood as comprising/including disclosed components, and may therefore include additional components not specifically described. Optionally, the embodiments disclosed herein are essentially free or completely free of components that are not specifically described. That is, non-disclosed components may optionally be completely omitted or essentially omitted from the disclosed embodiments. For example, monomers, polymer types, nanoparticle synthesis or storage components (e.g., capping agents, reducing agents, stabilizers) that are not specifically disclosed herein can optionally be completely or essentially omitted.

An embodiment that “essentially omits” or is “essentially free of” a component may include trace amounts and/or non-functional amounts of the component. For example, an “essentially omitted” component may be included in an amount no more than 2.5%, no more than 1%, no more than 0.1%, or no more than 0.01% by total weight of the composition. This is likewise applicable to other negative modifier phrases such as, but not limited to, “essentially omits,” “essentially without,” similar phrases using “substantially” or other synonyms of “essentially,” and the like.

A composition that “completely omits” or is “completely free of” a component does not include a detectable amount of the component (i.e., does not include an amount above any inherent background signal associated with the testing instrument) when analyzed using standard coating composition analysis techniques such as, for example, chromatographic techniques (e.g., thin-layer chromatography (TLC), gas chromatography (GC), liquid chromatography (LC)), or spectroscopy techniques (e.g., Fourier transform infrared (FTIR) spectroscopy).

1. A thermoplastic polymer material with antimicrobial properties, comprising:
a thermoplastic polymer having a surface portion and an interior bulk portion disposed below the surface portion, wherein the surface portion is an outer 100 nm of the thermoplastic polymer; and
a plurality of metal nanoparticles incorporated within the thermoplastic polymer and distributed throughout at least a portion of the volume of the thermoplastic polymer,
wherein the concentration of the metal nanoparticles in the outer surface portion is greater than the concentration of the metal nanoparticles within the interior bulk portion.

2. The thermoplastic polymer material of claim 1, wherein the concentration of the metal nanoparticles in the surface portion is up to about 10 times, up to about 8 times, up to about 6 times, up to about 5 times, or up to about 4 times, greater than the concentration of the metal nanoparticles within the interior bulk portion, such as between about 1.5 times to about 10 times greater than the concentration of the metal nanoparticles within the interior bulk portion.

3. The thermoplastic polymer material of claim 1, wherein the metal nanoparticles comprise silver nanoparticles.

4. The thermoplastic polymer material of claim 1, wherein the metal nanoparticles are ground state metal nanoparticles formed by laser ablation and wherein the metal nanoparticles omit capping agents or coating agents.

5. The thermoplastic polymer material of claim 1, wherein the metal nanoparticles are spherical-shaped with a sphericity of at least about 0.99.

6. The thermoplastic polymer material of claim 1, wherein the metal nanoparticles have an average particle size of 1 nm to 20 nm, such as about 8 nm to 12 nm.

7. The thermoplastic polymer material of claim 1, wherein the metal nanoparticles are included in at least the surface portion at a concentration of about 2 ppm to about 2000 ppm, about 10 ppm to about 1400 ppm, about 20 ppm to about 1000, about 30 ppm to about 500 ppm, about 50 ppm to about 250 ppm, or about 70 ppm to about 150 ppm.

8. The thermoplastic polymer material of claim 1, wherein the metal nanoparticles have a particle size distribution wherein at least 99% of the metal nanoparticles have a particle size within 30% of the mean diameter, or within 20% of the mean diameter, or within 10% of the mean diameter, and/or wherein at least 99% of the spherical-shaped nanoparticles have a diameter within ±3 nm of the mean diameter, or within ±2 nm of the mean diameter, or within ±1 nm of the mean diameter.

9. A medical device or other polymer product comprising the thermoplastic polymer material as in claim 1.

10. A method of manufacturing a thermoplastic polymer material, comprising:
forming or providing an intermediate thermoplastic polymer composition comprising a thermoplastic polymer with incorporated metal nanoparticles;
heating the intermediate thermoplastic polymer composition to form a molten thermoplastic polymer composition;
shaping the molten thermoplastic polymer composition into a desired shape of an intermediate polymer product in a heated state; and
subjecting the intermediate polymer product in a heated state to a controlled cooling process that comprises contacting the intermediate polymer product in a heated state with a cooling bath,
wherein the temperature difference (ΔT) between the temperature of the intermediate polymer product in a heated state (T_{polymer}) and the temperature of the cooling bath (T_{bath}) is 290° F. or less, such as about 200° F. to about 270° F., and
wherein the controlled cooling process causes migration of metal nanoparticles toward a surface portion of the thermoplastic polymer such that the surface portion has a higher concentration of metal nanoparticles than an interior bulk portion, wherein the surface portion is an outer 100 nm of the thermoplastic polymer.

11. The method of claim 10, wherein the T_{bath} is about 60° F. to about 120° F., such as about 70° F. to about 100° F.

12. The method of claim 10, wherein the cooling bath includes metal nanoparticles.

13. The method of claim 10, further comprising annealing the thermoplastic polymer after the controlled cooling process to cause further migration of metal nanoparticles to the surface portion.

14. The method of claim 10, further comprising etching the surface of the thermoplastic polymer to expose metal nanoparticles near the surface portion.

15. The method of claim 10, further comprising applying a coating to the thermoplastic polymer material, wherein the coating is a different polymer than the thermoplastic polymer.

16. The method of claim 10, wherein the thermoplastic polymer is heated in an extrusion or molding process prior to being subjected to the cooling bath.

17. The method of claim 10, wherein the metal nanoparticles are incorporated into the thermoplastic polymer by:
i) applying a solvent-based solution comprising the metal nanoparticles to thermoplastic polymer granules;
ii) removing the solvent-based solution by evaporation,
iii) heating the thermoplastic polymer granules into a molten polymer to thereby incorporate the metal nanoparticles, and
repeating steps i) and ii) one or more times before or after step iii).

18. The method of claim 17, wherein the solvent-based solution is applied to the thermoplastic polymer granules by spraying.

19. The method of claim 17, wherein the solvent-based solution is applied to the thermoplastic polymer granules using a centrifuge.

20. A thermoplastic polymer material manufactured according to method of claim 10.
